(19) United States
(12) Patent Application Publication
(10) Pub. No.: US 2013/0156889 A1
(43) Pub. Date: Jun. 20, 2013

(54) GREEK YOGURT DIPS AND SPREADS AND PRODUCTION THEREOF

(71) Applicants: Craig J. Schroeder, Springfield, MO (US); Joshua Paul Busby, Rogersville, MO (US)

(72) Inventors: Craig J. Schroeder, Springfield, MO (US); Joshua Paul Busby, Rogersville, MO (US)

(73) Assignee: DAIRY FARMERS OF AMERICA, INC., Kansas City, MO (US)

(21) Appl. No.: 13/325,962

(22) Filed: Dec. 14, 2011

(51) Int. Cl. A23C 9/123; A23C 21/02; A23C 9/137

(52) U.S. Cl. 426/41; 426/583; 426/575; 426/576; 426/577; 426/578; 426/43

(57) ABSTRACT

High-viscosity Greek yogurt products are provided in the form of a homogeneous mass including from about 20-35% by weight total solids and water, where from about 85-97% by weight of the solids fraction is in the form of dairy solids. The products have a viscosity of from about 60,000-90,000 cP, and are produced by forming a solids-water mixture, heating and homogenizing the mixture, and then culturing the heating and homogenized mixture with a yogurt culture to a break pH of from about 3.5-5. The products can be mixed with any suitable flavoring agent before or during packaging, as desired. The products may be used as spreads or dips, for example.

### BACKGROUND OF THE INVENTION

1. Field of the Invention

The present invention is broadly concerned with high viscosity Greek yogurt products, such as dips or spreads, which have a consistency and mouth feel typical of cream cheese. More particularly, the invention is concerned with cultured Greek yogurt products which can be blended with various flavoring agents, and which have a viscosity of from about 60,000-90,000 cP, rendering them useful in the formulation of a variety of final foods.

2. Description of the Prior Art

Over the last several decades, yogurt and its preparations have developed into well-accepted and consumed dairy products. A mildly acidic taste, good digestibility, variations in taste, and a high dietetic value have significantly contributed to the increased marketplace acceptance of yogurts.

Traditional yogurts are firm, creamy, or liquid acidified milk products which are manufactured from milk or a milk component by using thermophilic lactic acid bacteria. In order to increase dry matter, powdered milk or other dairy solids may be added during the production process. In the United States, yogurt is defined in 21 C.F.R. §131.200. This standard defines the composition, allowed and required ingredients, and labeling requirements for traditional yogurts.

So-called Greek yogurts (also known as strained yogurt, yogurt cheese, or labneh) have also been prepared in the past. These products can be produced by straining a conventional yogurt using cloth or paper bag to filter and remove whey, giving a consistency between that of yogurt and cheese, while preserving yogurt's distinct sour taste. Yogurt strained through muslin is a traditional food in the Levant, Eastern Mediterranean, Middle East, and South Asia, where it is often used in cooking. Greek yogurts are relatively high in protein, and have a smooth, pleasing taste. Typical Greek yogurts have viscosities on the order of 21,000 cP.

U.S. Pat. No. 4,968,512 describes methods for making low-fat, low-calorie, yogurt spreads by removing the majority of fat and moisture from milk, heating the treated milk to a temperature in excess of 180° F., cooling the milk to about 107° F., and culturing the cooled milk using yogurt culture to obtain yogurt in a solid mass form. See also, U.S. Pat. No. 4,434,184.

### SUMMARY OF THE INVENTION

The present invention provides very high viscosity Greek yogurt products, such as dips or spreads, which are in the form of a homogeneous mass having 20-35% by weight total solids, where from about 85-97% by weight of the solids fraction is in the form of dairy solids, and water. The products have a viscosity of from about 60,000-120,000 cP at 100° F., and a protein content of from about 5-15% by weight, more preferably from about 7-12% by weight. The products of the invention are produced by heating and homogenizing a solids-water mixture, followed by culturing the mixture with a yogurt culture to an acidic pH of from about 3.5-5. This product can then be mixed with a variety of flavoring agents, such as fruits or spices, to yield a final food product.

### DETAILED DESCRIPTION OF THE PREFERRED EMBODIMENT

The Greek yogurt products in accordance with the invention are preferably produced as preblend products which can be blended with any number of possible flavorings such as fruits and spices to create final saleable products. The preblend products in accordance with the invention are in the form of high-viscosity, cultured, homogeneous masses (sometimes referred to as white mass) including a solids fraction and a water fraction.

In more detail, the method of preparing the products of the invention involves initially forming a hydrated solids-water mixture having a total solids content of from about 20-35% by weight, with a corresponding water content of from about 60-80% by weight (unless indicated otherwise, all weight percentages are based upon the total weight of the preblend product taken as 100% by weight). More preferably, the solids-water mixture includes from about 20-40% by weight solids and from about 60-80% by weight water. Importantly, from about 85-97% by weight (more preferably from about 88-95% by weight) of the solids fraction is in the form of dairy solids, especially those selected from the group consisting of whole milk solids, skim milk solids, milk protein concentrate, whey protein concentrate, cream, butter, clarified butter oil, anhydrous milk fat, and mixtures thereof. The balance of the solids fraction may include one or more water-binding agents, such as hydrocolloids, carbohydrates, or mixtures thereof, e.g., agents selected from the group consisting of agar, carrageenan, gelatin, pectin, xanthan gum, gum arabic, guar gum, locust bean gum, carboxymethyl cellulose, alginate, starch, and mixtures thereof. If starch is employed, it may be selected from virtually any type of known starch, such as grain, root, or tuber starches, e.g., potato, tapioca, rice, wheat, oats, barley, corn, rye, sorghum, arrow root, and mixtures thereof.

In the next step, the solids-water mixture is heated under time-temperature conditions to fully cook the mixture. This can be done using a high-temperature, short-time (HTST) heating protocol, or by batch processing in a tank with longer hold times and lower temperatures. Generally, in batch processing, it has been found that the solids-water mixture should be heated to a temperature of from about 150-175° F. for a period of from about 30-90 minutes, with or without mild agitation. In the case of HTST processing, the mixtures should be treated at a temperature of from about 160-180° F. for a period of from about 3 seconds to 5 minutes.

The heated solids-water mixture is then subjected to homogenization. Although not critical, it has been found that single-stage homogenization at a pressure of from about 800-3000 psi.

Following homogenization, the solids-water mixture is cultured using one or more yogurt cultures with or without a probiotic culture until a break pH of from about 3.5-5, and more preferably from about 3.9-4.5, is achieved. The final cultured preblend has a viscosity of from about 60,000-100,000 cP (cP values were measured at 70° F. using a Brookfield Viscometer); a water content of from about 65-80% by weight; a fat content of from about 2-10% by weight, more preferably from about 4-8% by weight; a protein content of from about 5-15% by weight, more preferably from about 8-12% by weight; and a total solids content of from about 12-40% by weight, more preferably from about 23-35% by weight. Generally, spread products in accordance with the invention have a higher solids content as compared with the dip products.

Blending flavoring agent(s) into the cultured preblend product can be accomplished prior to or during bulk or consumer packaging. Any convenient technique can be used to achieve such blending.

The following Examples set forth preferred procedures for producing preblend products in accordance with the invention. It is to be understood, however, that these examples are provided by way of illustration only, and nothing therein should be taken to be a limitation upon the overall scope of the invention.

### Example 1

A 6% fat Greek yogurt spread product was prepared using the following ingredients:

TABLE 1

| INGREDIENT | % SOLIDS | % FAT | % OF PRODUCT |
|---|---|---|---|
| cream | 42.44 | 38 | 14.75 |
| milk | 12.54 | 3.8 | 11 |
| NFDM-LH | 97 | 0 | 3.5 |
| WPC 34 | 97 | 0 | 3 |
| tapioca starch | 100 | 0 | 1.5 |
| MPC 70 | 97 | 0 | 9 |
| pectin | 100 | 0 | 0.3 |
| water | 0 | 0 | 56.25 |
| yogurt cultures | — | 0 | 0.7 |

NFDM-LH: non-fat dry milk, low heat, powder resulting from removal of fat and water from fresh milk under low heat conditions
WPC 34: whey protein concentrate, 34-36% protein
tapioca starch: Tenderfil 428
MPC 70: milk protein concentrate, 70% protein
yogurt cultures: one box each of Chr Hansen YC-X11 and BB12 culture

In the process, water is initially added to a mixing tank, followed by addition of NFDM-LH, WPC 34, and MPC 70. The powders were mixed and allowed to hydrate. The tapioca starch and pectin were then added, followed by the cream and milk. The ingredients were then mixed with medium agitation until a substantially uniform mixture was achieved. The mixture was then heat-treated at 164° F. for one hour, followed by homogenization at 1,000 psi, single stage. The homogenized mixture was brought to a temperature of 100° F. and the cultures were added at 0.4%. The cultured mixture was then incubated for 6-10 hours, with a break at pH 4.2. The final product was then cooled to 45° F. or lower. The resultant white mass yogurt spread had a viscosity of about 72,000 cP, and desired spices, fruit, or other flavorings can be added prior to or concurrently with packaging.

### Example 2

A 10% fat Greek yogurt spread was prepared containing the following ingredients:

TABLE 2

| INGREDIENT | % SOLIDS | % FAT | % OF PRODUCT |
|---|---|---|---|
| cream | 46.37 | 41.07 | 20 |
| milk | 12.27 | 3.5 | 53.6 |
| condensed skim milk | 32.49 | 0 | 16 |
| WPC 34 | 97 | 0 | 3 |
| tapioca starch | 100 | 0 | 4 |
| MPC 70 | 97 | 0 | 1 |
| gelatin | 100 | 0 | 1 |
| probiotic culture | 0 | 0 | 0.7 |
| yogurt cultures | — | 0 | 0.7 |

probiotic culture: Chr. Hansen BB12, which contains several cultures, the most important being a Bifidobacterium species.

The manufacturing process is very similar to that of Example 1. In Example 1, use was made of NFDM powder which was reconstituted in water. In this Example, condensed skim milk is employed, which eliminates the need for additional water. Thus, in the present example, the condensed skim milk is initially added to a mixing tank, followed by addition of WPC 34, MPC 70, tapioca starch, and gelatin. The ingredients were mixed with medium agitation until a uniform mixture was achieved. The mixture was then heat treated at 164° F. for one hour, followed by homogenization at 1000 psi, single stage. The homogenized mixture was then brought to a temperature of 100° F. and the probiotic and yogurt cultures were added at 0.4%. The cultured mixture was then incubated for 6-10 hours, with a break at pH 4.2. The final product was then cooled to 45° F. or lower. The resultant white mass yogurt product had a viscosity of about 72,000 cP.

I claim:

1. A Greek yogurt product comprising a homogeneous mass including solids at a level of from about 20-35% by weight mixed with water, from about 85-97% by weight of said solids being dairy solids, said product having a viscosity of from about 60,000-120,000 cP at 100° F., said mass produced by heating and homogenizing a mixture of said solids and said water, followed by culturing the heated and homogenized mixture with a yogurt culture to a pH of from about 3.5-5.

2. The product of claim 1, said homogeneous mass having a water content of from about 65-80% by weight.

3. The product of claim 1, said solids being present at a level of from about 23-28% by weight.

4. The product of claim 3, said homogeneous mass having a water content of from about 72-77% by weight.

5. The product of claim 1, from about 88-95% by weight of said solids being dairy solids.

6. The product of claim 1, said dairy solids selected from the group consisting of whole milk solids, skim milk solids, milk protein concentrate, whey protein concentrate, cream, butter, clarified butter oil, anhydrous milk fat, and mixtures thereof.

7. The product of claim 1, said viscosity being from about 68,000-75,000 cP.

8. The product of claim 1, said pH being from about 3.9-4.5.

9. The product of claim 1, said product having from about 5-15% by weight protein.

10. The product of claim 9, said product having from about 7-12% by weight protein.

11. The product of claim 1, said product having a fat content of from about 2-10% by weight.

12. The product of claim 11, said product having a fat content of from about 4-8% by weight.

13. The product of claim 1, said solids including a water-binding agent.

14. The product of claim 13, said water-binding agent being selected from the group consisting of hydrocolloids, carbohydrates, and mixtures thereof.

15. The product of claim 13, said water-binding agent selected from the group consisting of agar, carrageenan, gelatin, pectin, xanthan gum, gum arabic, guar gum, locust bean gum, carboxymethyl cellulose, alginate, starch, and mixtures thereof.

16. The product of claim 1, said mixture being heated to a temperature of from about 150-175° F. for a period of from about 30-90 minutes.

17. The product of claim 1, said mixture being homogenized in a single-stage homogenizer at a pressure of from about 800-1500 psi.

18. The product of claim 1, said heated and homogenized mixture being cultured for a period of from about 5-12 hours.

19. The product of claim 1, including a quantity of flavoring mixed with said homogeneous mass.

20. A method of producing a Greek yogurt product comprising the steps of:
forming a mixture of from about 20-35% by weight solids in with water, from about 85-97% by weight of said solids being dairy solids;
heating said mixture;
homogenizing the heated mixture; and
culturing the heated and homogenized mixture with a yogurt culture to a pH of from about 3.5-5 to yield a substantially homogeneous mass, said mass having a viscosity of from about 60,000-120,000 cP at 100° F.

21. The method of claim 20, said homogeneous mass having a water content of from about 65-80% by weight.

22. The method of claim 20, said solids being present at a level of from about 23-28% by weight.

23. The method of claim 22, said homogeneous mass having a water content of from about 72-77% by weight.

24. The method of claim 20, from about 88-95% by weight of said solids being dairy solids.

25. The method of claim 20, said dairy solids selected from the group consisting of whole milk solids, skim milk solids, milk protein concentrate, whey protein concentrate, cream, butter, clarified butter oil, anhydrous milk fat, and mixtures thereof.

26. The method of claim 20, said viscosity being from about 68,000-75,000 cP.

27. The method of claim 20, said pH being from about 3.9-4.5.

28. The method of claim 20, said product having from about 5-15% by weight protein.

29. The method of claim 28, said product having from about 7-12% by weight protein.

30. The method of claim 20, said product having a fat content of from about 2-10% by weight.

31. The method of claim 30, said product having a fat content of from about 4-8% by weight.

32. The method of claim 20, said solids including a water-binding agent.

33. The method of claim 32, said water-binding agent being selected from the group consisting of hydrocolloids, carbohydrates, and mixtures thereof

34. The method of claim 32, said water-binding agent selected from the group consisting of agar, carrageenan, gelatin, pectin, xanthan gum, gum arabic, guar gum, locust bean gum, carboxymethyl cellulose, alginate, starch, and mixtures thereof.

35. The method of claim 20, said mixture being heated to a temperature of from about 150-175° F. for a period of from about 30-90 minutes.

36. The method of claim 20, said mixture being homogenized in a single-stage homogenizer at a pressure of from about 800-1500 psi.

37. The method of claim 20, said heated and homogenized mixture being cultured for a period of from about 5-12 hours.

38. The method of claim 20, including a quantity of flavoring mixed with said homogeneous mass.
